(19) United States
(12) Patent Application Publication
(10) Pub. No.: US 2013/0241218 A1
(43) Pub. Date: Sep. 19, 2013

(54) VEHICLE BUMPER REINFORCEMENT

(71) Applicants: AISIN SEIKI KABUSHIKI KAISHA, Kariya-shi (JP); AISIN KEIKINZOKU KABUSHIKI KAISHA, Imizu-shi (JP)

(72) Inventors: Yasuhisa TSUCHIDA, Nagoya-shi (JP); Kyosuke MATSUI, Chiryu-shi (JP); Tamaki OBAYASHI, Toyama-shi (JP); Takanari YOSHIMURA, Takaoka-shi (JP)

(73) Assignees: AISIN KEIKINZOKU KABUSHIKI KAISHA, Imizu-shi (JP); AISIN SEIKI KABUSHIKI KAISHA, Kariya-shi (JP)

(21) Appl. No.: 13/794,872

(22) Filed: Mar. 12, 2013

(30) Foreign Application Priority Data
Mar. 14, 2012 (JP) 2012-057610

(51) Int. Cl. B60R 19/34

(52) U.S. Cl. CPC B60R 19/34
USPC 293/133

(57) ABSTRACT

Provided is a vehicle bumper reinforcement including: an inner-wall section in a long shape along the width direction of a vehicle; an outer-wall section formed in a long shape so as to be arranged to face the inner-wall section; an upper-wall section connecting an upper end side of the inner-wall section and an upper end side of the outer-wall section; and a lower-wall section connecting a lower end side of the inner-wall section and a lower end side of the outer-wall section. The inner-wall section has a first concave section with a bottom, which is formed along a longitudinal direction thereof, the outer-wall section has a second concave section with a bottom, which is formed along a longitudinal direction thereof, and a bottom surface of the first concave section and a bottom surface of the second concave section are arranged to face each other.

### CROSS REFERENCE TO RELATED APPLICATIONS

This application is based on and claims priority under 35 U.S.C. §119 to Japanese Patent Application 2012-057610, filed on Mar. 14, 2012, the entire content of which is incorporated herein by reference.

### TECHNICAL FIELD

This disclosure relates to a vehicle bumper reinforcement.

### BACKGROUND DISCUSSION

A vehicle bumper reinforcement is formed in a long shape along the width direction of a vehicle and is provided in a front portion or a rear portion of the vehicle. The vehicle bumper reinforcement absorbs an impact when the vehicle receives the impact from outside (the front or the rear) of the vehicle.

Generally, the vehicle bumper reinforcement includes an inner-wall section, an outer-wall section, an upper-wall section and a lower-wall section, and has a tube shape to enclose a closed space which is surrounded by the wall sections. The inner-wall section is formed in a long shape along the width direction of the vehicle and, for example, is connected to a member of a vehicle body side such as a side member or a crash box. The outer-wall section is formed in a long shape along the width direction of the vehicle so as to face the inner-wall section on the outside (for example, front side) from the inner-wall section. An impact load acts on the outer-wall section from the outside. The upper-wall section connects an upper end of the inner-wall section and an upper end of the outer-wall section. The lower-wall section connects a lower end of the inner-wall section and a lower end of the outer-wall section.

In the vehicle bumper reinforcement, high buckling strength is required for the impact load so that the impact load acting from the outer-wall section is sufficiently absorbed. Accordingly, in the related art, an improved vehicle bumper reinforcement has been suggested to have a high buckling strength for the impact load. For example, a vehicle bumper reinforcement having cross-section shape which, when cut in a plane perpendicular to the longitudinal direction, is substantially B shape, has been suggested.

FIG. 8 is a schematic cross-sectional view in which a vehicle bumper reinforcement P having a cross-section of B shape, which is mounted on the front portion of the vehicle, is cut in a plane perpendicular to the longitudinal direction thereof. The vehicle bumper reinforcement P includes a rear-wall section (an inner-wall section) P1, a front-wall section (an outer-wall section) P2, an upper-wall section P3 and a lower-wall section P4. The rear-wall section P1 is formed in a long shape along the width direction of the vehicle and is connected to a member of a vehicle body side. The front-wall section P2 is formed in a long shape along the width direction of the vehicle so as to be arranged to face the rear-wall section P1 in the front from the rear-wall section P1. An impact load acts on the front-wall section P2 from the outside. The upper-wall section P3 connects the upper end of the rear-wall section P1 and the upper end of the front-wall section P2. The lower-wall section P4 connects the lower end of the rear-wall section P1 and the lower end of the front-wall section P2.

In addition, in the rear-wall section P1, a rear-wall side concave section P5, which is formed in a substantially center portion in the vertical direction thereof so as to be recessed toward the front side, is formed in a groove shape along the longitudinal direction thereof. Accordingly, the rear-wall section P1 of the vehicle bumper reinforcement P has an upper rear-wall section P11 which is positioned above the rear-wall side concave section P5 and a lower rear-wall section P12 which is positioned below the rear-wall side concave section P5. In addition, an upper side-wall section P6 is formed so as to extend from the lower end of the upper rear-wall section P11 to the front side (outside) and a lower side-wall section P7 is formed so as to extend from the upper end of the lower rear-wall section P12 to the front side (outside). Then, the front end (the outside end) of the upper side-wall section P6 and the front end (outside end) of the lower side-wall section P7 are connected by a bottom-wall section P8. A surface facing the front side (the outside) of the bottom-wall section P8 comes into contact with a surface facing the rear side (inside) of the front-wall section P2. According to the vehicle bumper reinforcement P having such a cross-section of B shape, a tube-shaped upper tube portion is formed by the upper portion configured of the upper-wall section P3, the upper rear-wall section P11, the upper side-wall section

P6 and the front-wall section P2, and a tube-shaped lower tube portion is formed by a lower portion configured of the lower-wall section P4, the lower rear-wall section P12, the lower side-wall section P7 and the front-wall section P2.

The impact load, which acts on the front-wall section P2 of the vehicle bumper reinforcement P having the cross-section of B shape from the front side to the rear side, is transmitted to the upper-wall section P3 and the lower-wall section P4. In addition, since the front-wall section P2 and the bottom-wall section P8 come into contact with each other, the impact load is transmitted to the upper side-wall section P6 and the lower side-wall section P7 via the bottom-wall section P8, respectively. Since the portions (the upper-wall section P3, the lower-wall section P4, the upper side-wall section P6 and the lower side-wall section P7) extend in a direction (a front-rear direction of the vehicle) of the action of the impact load, the portions function as a rib against the impact load. In other words, the impact load acts on four ribs at the same time. Thus, the vehicle bumper reinforcement P having the cross-section of B shape is buckled by the impact load in four locations, thereby absorbing the impact load.

On the other hand, the impact load, which acts on the outer-wall section (for example, the front-wall section) of a typical vehicle bumper reinforcement having a cross-sectional shape which, when cut in a plane perpendicular to the longitudinal direction, is rectangular shape, is transmitted only in the upper-wall section and the lower-wall section. In other words, the impact load acts on two ribs at the same time. Accordingly, the typical vehicle bumper reinforcement is buckled by the impact load in two locations, thereby absorbing the impact load.

As described above, the number of the locations, in which the vehicle bumper reinforcement having the cross-section of B shape is buckled by the impact load, is greater than the number of the locations in which a typical vehicle bumper reinforcement is buckled by the impact load. Accordingly, the buckling strength thereof is higher than that of the typical vehicle bumper reinforcement.

In JP 2010-507532A (Reference 1) and JP 2010-215062A (Reference 2), an improved vehicle bumper reinforcement having a cross-section of B shape is disclosed. According to the vehicle bumper reinforcement disclosed in Reference 1, a concave section (a groove section) is formed along the longitudinal direction at a substantially center portion in the vertical direction of the upper portion of the front-wall section configuring the upper tube portion and at a substantially center portion in the vertical direction of the lower portion of the front-wall section configuring the lower tube portion. The concave section is indicated as a symbol P9 in FIG. 8. In Reference 1, such a concave section is referred to as a power rib. A bending strength against the impact load is improved by forming the power rib.

Furthermore, in Reference 2, a vehicle bumper reinforcement having a cross-section of B shape, in which a reinforcement plate-shaped member is installed in an upper-wall section configuring the upper tube portion and a lower-wall section configuring a lower tube portion, is disclosed, According to the vehicle bumper reinforcement, the buckling strength against the impact load is further improved by the reinforcement plate-shaped member which is mounted on the upper and lower sides.

According to the vehicle bumper reinforcement disclosed in Reference 1, the bending strength against the impact load is improved by the power ribs which are formed in the upper tube portion and the lower tube portion, respectively. However, the buckling strength is unlikely to be greatly improved. Accordingly, in order to improve the buckling strength, for example, the thickness of the plate configuring the vehicle bumper reinforcement should be increased. In this case, material cost increases. Furthermore, in the vehicle bumper reinforcement disclosed in Reference 2, since the reinforcing ribs should be mounted on the upper and lower sides thereof, an increase in working operations and material costs increases due to separately providing the reinforcing ribs.

A need thus exists for a vehicle bumper reinforcement which is not susceptible to the drawback mentioned above.

### SUMMARY

According to an aspect of this disclosure, there is provided a vehicle bumper reinforcement including: an inner-wall section which is formed in a long shape along a width direction of a vehicle and is connected to a member of a vehicle body side; an outer-wall section which is formed in a long shape so as to be arranged to face the inner-wall section along the width direction of the vehicle and on which an impact load acts from an outside; an upper-wall section which connects an upper end side of the inner-wall section and an upper end side of the outer-wall section; and a lower-wall section which connects a lower end side of the inner-wall section and a lower end side of the outer-wall section. The inner-wall section has a first concave section with a bottom, which is formed along a longitudinal direction of the inner-wall section so as to be recessed towards the outside, the outer-wall section has a second concave section with a bottom, which is formed along a longitudinal direction thereof so as to be recessed towards an inside, and a bottom surface of the first concave section and a bottom surface of the second concave section are arranged to face each other so as to come into contact with each other.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a vehicle bumper reinforcement according to an embodiment;

FIG. 2 is a plan view of the vehicle bumper reinforcement according to the embodiment;

FIG. 3 is a front view of the vehicle bumper reinforcement according to the embodiment;

FIG. 4 is a cross-sectional view which is taken along line IV-IV in FIG. 3;

FIG. 5 is a schematic cross-sectional view illustrating a state where the vehicle bumper reinforcement according to the embodiment is buckled by an impact load;

FIG. 6 is a schematic cross-sectional view illustrating a state where the vehicle bumper reinforcement having a cross-section of a B shape is buckled by the impact load;

FIG. 7 is a graph illustrating a relationship between a deflection amount to the rear of the vehicle bumper reinforcement and a pressing load which the vehicle bumper reinforcement receives from an object in a case where the object is pressed on the front surface of the front-wall section of the vehicle bumper reinforcement of the embodiment; and

FIG. 8 is a schematic cross-sectional view in which the vehicle bumper reinforcement having a cross-section of a B shape installed in the front portion of the vehicle is cut in a plane perpendicular to the longitudinal direction thereof.

### DETAILED DESCRIPTION

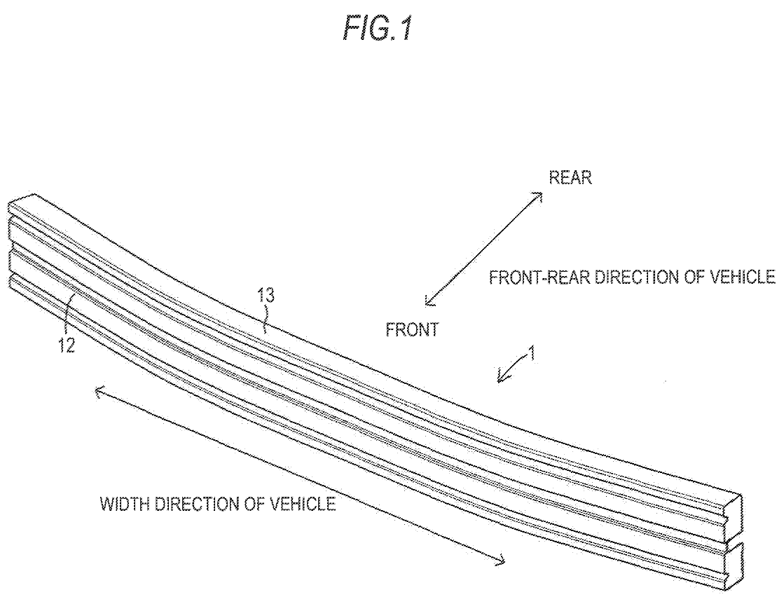

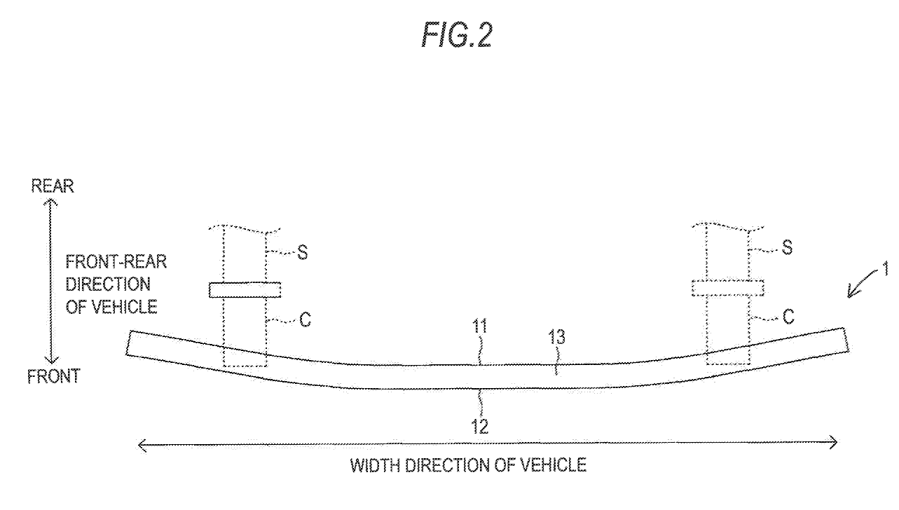

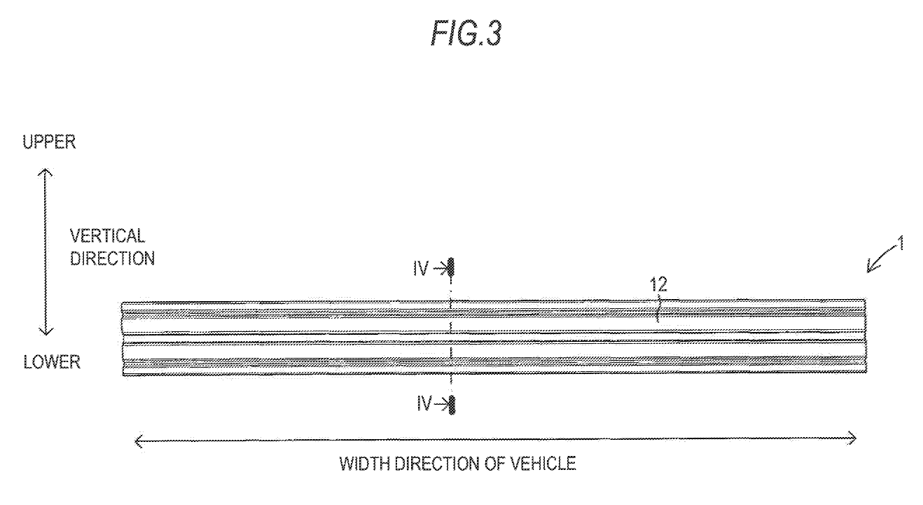

A vehicle bumper reinforcement according to an embodiment disclosed here will be described based on the drawings. FIG. 1 is a perspective view of the vehicle bumper reinforcement according to the embodiment, FIG. 2 is a plan view thereof and FIG. 3 is a front view thereof. In addition, in the embodiment, the vehicle bumper reinforcement installed in the front side of the vehicle will be described, however, the vehicle bumper reinforcement according to the embodiment may be applied to the vehicle bumper reinforcement installed on the rear side of the vehicle.

As illustrated in FIGS. 2 and 3, a vehicle bumper reinforcement 1 is formed in a long shape along the width direction of the vehicle. The vehicle bumper reinforcement 1 is formed, for example, by bending in roll-forming or by extruding of a sheet of metal plate (for example, aluminum alloy plate, steel plate, or the like). In addition, in this specification, in a case of being “formed along the width direction of the vehicle”, it is not necessary to be strictly formed linearly along the width direction of the vehicle and it may be formed so as to follow a shape which is along the width direction of the front side or the rear side of the vehicle. For example, like the vehicle bumper reinforcement 1 illustrated in FIGS. 1 and 2, even though vicinity of both ends in the longitudinal direction is formed to be curved, it may be said that it is formed along the width direction of the vehicle.

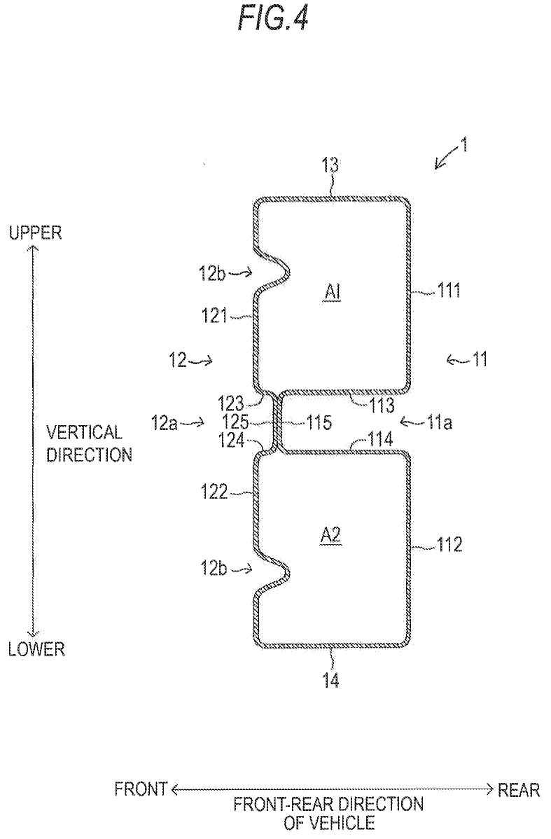

FIG. 4 is a cross-sectional view which is taken along line IV-IV in FIG. 3. The cross-section illustrated in FIG. 4 is a cross-section in which the vehicle bumper reinforcement 1 is cut in a plane perpendicular to the longitudinal direction thereof. As illustrated in FIG. 4, the vehicle bumper reinforcement 1 includes a rear-wall section (an inner-wall section) 11, a front-wall section (an outer-wall section) 12, an upper-wall section 13 and a lower-wall section 14.

The rear-wall section 11 extends in the vertical direction in the cross-section illustrated in FIG. 4. In addition, as illustrated in FIG. 2, the rear-wall section 11 is formed in a long shape along the width direction of the vehicle and is connected via a crash box C to a front end of a side member S. which is a member of the vehicle body side in the vicinity of both ends in the longitudinal direction. Accordingly, the vehicle bumper reinforcement 1 is supported on the side member S via the crash box C.

The front-wall section 12 also extends in the vertical direction in the cross-section illustrated in FIG. 4. Similar to the rear-wall section 11, the front-wall section 12 is also formed in a long shape along the width direction of the vehicle. As illustrated in FIG. 4, the front-wall section 12 is arranged in the front side (outside) from the rear-wall section 11 to face the rear-wall section 11. An impact load acts on the front-wall section 12 from the front side (outside).

The upper-wall section 13 is formed to make the upper end of the rear-wall section 11 and the upper end of the front-wall section 12 to be connected. The lower-wall section 14 is formed to make the lower end of the rear-wall section 11 and the lower end of the front-wall section 12 to be connected. The upper-wall section 13 and the lower-wall section 14 extend in a front-rear direction of the vehicle in the cross-section illustrated in FIG. 4.

As illustrated in FIG. 4, a first concave section 11a having a bottom is formed in the substantially center portion of the rear-wall section 11 in the vertical direction. The first concave section 11a is formed in a groove shape along the longitudinal direction (the width direction of the vehicle) thereof thereby being recessed from the rear-wall section 11 towards the front side (outside). Accordingly, the rear-wall section 11 is configured to have an upper rear-wall section 111 which is positioned at an upper side of the first concave section 11a and a lower rear-wall section 112 which is positioned at a lower side of the first concave section 11a, as the first concave section 11a marking a boundary.

A first upper side-wall section 113 is provided so as to extend horizontally from the lower end of the upper rear-wall section 111 towards the front side (outside) and a first lower side-wall section 114 is provided so as to extend horizontally from the upper end of the lower rear-wall section 112 towards the front side (outside). Furthermore, a first bottom-wall section 115 is formed so as to make the front end (outside end) of the first upper side-wall section 113 and the front end (outside end) of the first lower side-wall section 114 to be connected. The first concave section 11a, which is open on the rear side (inside), is formed by the first upper side-wall section 113, the first lower side-wall section 114 and the first bottom-wall section 115.

In addition, a second concave section 12a having a bottom is formed in the substantially center portion of the front-wall section 12 in the vertical direction. The second concave section 12a is formed in a groove shape along the longitudinal direction (the width direction of the vehicle) thereof thereby being depressed from the front-wall section 12 towards the rear side (inside). Accordingly, the front-wall section 12 is configured to have an upper front-wall section 121 which is positioned at an upper side of the second concave section 12a and a lower front-wall section 122 which is positioned at a lower side of the second concave section 12a as the second concave section 12a marking a boundary.

A second upper side-wall section 123 is provided so as to extend horizontally from the lower end of the upper front-wall section 121 towards the rear side (inside) and a second lower side-wall section 124 is provided so as to extend horizontally from the upper end of the lower front-wall section 122 towards the rear side (inside). Furthermore, a second bottom-wall section 125 is formed so as to make the rear end (inside end) of the second upper side-wall section 123 and the rear end (inside end) of the second lower side-wall section 124 to be connected. The second concave section 12a, which is open on the front side (outside), is formed by the second upper side-wall section 123, the second lower side-wall section 124 and the second bottom-wall section 125.

The first bottom-wall section 115 and the second bottom-wall section 125 extend in a vertical direction in the cross-section illustrated in FIG. 4. In addition, as illustrated in FIG. 4, the first bottom-wall section 115 and the second bottom-wall section 125 are arranged to face each other so that a surface (outside surface) facing the front side of the first bottom-wall section 115 and a surface (inside surface) facing the rear side of the second bottom-wall section 125 come into contact with each other, Accordingly, one closed space (an upper closed space A1) is formed by the upper rear-wall section 111, the upper front-wall section 121, the upper-wall section 13, the first upper side-wall section 113 and the second upper side-wall section 123. One closed space (a lower closed space A2) is formed by the lower rear-wall section 112, the lower front-wall section 122, the lower-wall section 14, the first lower side-wall section 114 and the second lower side-wall section 124. Accordingly, a portion forming the upper closed space A1 and a portion forming the lower closed space A2 are connected to each other by the first bottom-wall section 115 and the second bottom-wall section 125.

In the embodiment, the lengths of the first upper side-wall section 113 and the first lower side-wall section 114 are the same as each other. The lengths of the second upper side-wall section 123 and the second lower side-wall section 124 are the same as each other. In addition, as clearly illustrated in FIG. 4, the lengths of the first upper side-wall section 113 and the first lower side-wall section 114 are longer than the lengths of the second upper side-wall section 123 and the second lower side-wall section 124. In other words, the depth of the second concave section 12a is shallower than the depth of the first concave section 11a. The depth of the second concave section 12a may be approximately ½ to ⅛ of the depth of the first concave section 11a,

In addition, concave sections 12b and 12b are formed in the upper front-wall section 121 and the lower front-wall section 122, respectively. The concave section 12b is formed in a groove shape along the longitudinal direction (the width direction of the vehicle) of the front-wall section 12 so as to be recessed towards the rear side.

In the vehicle bumper reinforcement 1 having the configuration described above, description will be given regarding how the vehicle bumper reinforcement 1 is buckled, in a case where the impact load is applied to the front-wall section 12 (the upper front-wall section 121 and the lower front-wall section 122) from the front side (outside) towards the rear side (inside).

The impact load applied to the upper front-wall section 121 is transmitted to the upper-wall section 13 and the second upper side-wall section 123, and the impact load applied to the lower front-wall section 122 is transmitted to the lower-wall section 14 and the second lower side-wall section 124.

Furthermore, the impact load transmitted to the second upper side-wall section 123 and the second lower side-wall section 124 is also transmitted to the first upper side-wall section 113 and the first lower side-wall section 114 via the second bottom-wall section 125 and the first bottom-wall section 115 which come into contact with each other. Accordingly, the impact load applied to the upper front-wall section 121 and the lower front-wall section 122 is transmitted to the upper-wall section 13, the lower-wall section 14, the second upper side-wall section 123, the second lower side-wall section 124, the first upper side-wall section 113 and the first lower side-wall section 114, respectively and at the same time.

As illustrated in FIG. 4, the upper-wall section 13, the lower-wall section 14, the second upper side-wall section 123, the second lower side-wall section 124, the first upper side-wall section 113 and the first lower side-wall section 114 extend in the front-rear direction of the vehicle. In other words, those sections extend parallel to an action direction (a direction from the front side to the rear side) of the impact load. Accordingly, those sections function as ribs against the impact load and, at the same time, are buckled by the impact load thereby absorbing the impact load.

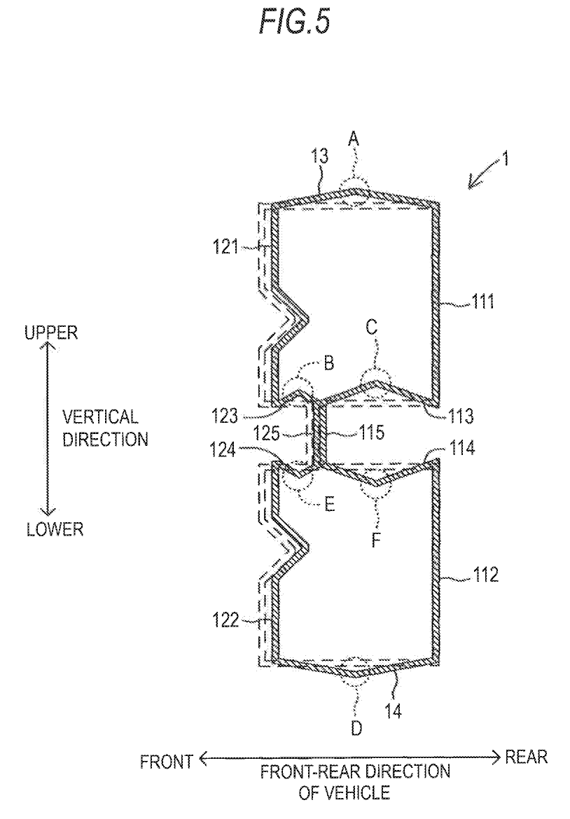

FIG. 5 is a schematic cross-sectional view illustrating a state where the vehicle bumper reinforcement 1 according to the embodiment is buckled by the impact load. In FIG. 5, a cross-section of the vehicle bumper reinforcement 1 before being buckled is illustrated in dot lines. In a case where the impact load acts on the upper front-wall section 121 and the lower front-wall section 122 of the vehicle bumper reinforcement 1 from the front side to the rear side, the upper-wall section 13 is buckled, for example, in portion A in FIG. 5, the second upper side-wall section 123 is buckled in portion B, the first upper side-wall section 113 is buckled in portion C, the lower-wall section 14 is buckled in portion Q, the second lower side-wall section 124 is buckled in portion E and the first lower side-wall section 114 is buckled in portion F. The buckling in those portions occurs substantially at the same time, Accordingly, the vehicle bumper reinforcement 1 of the embodiment is configured so as to be buckled in six locations against the impact load.

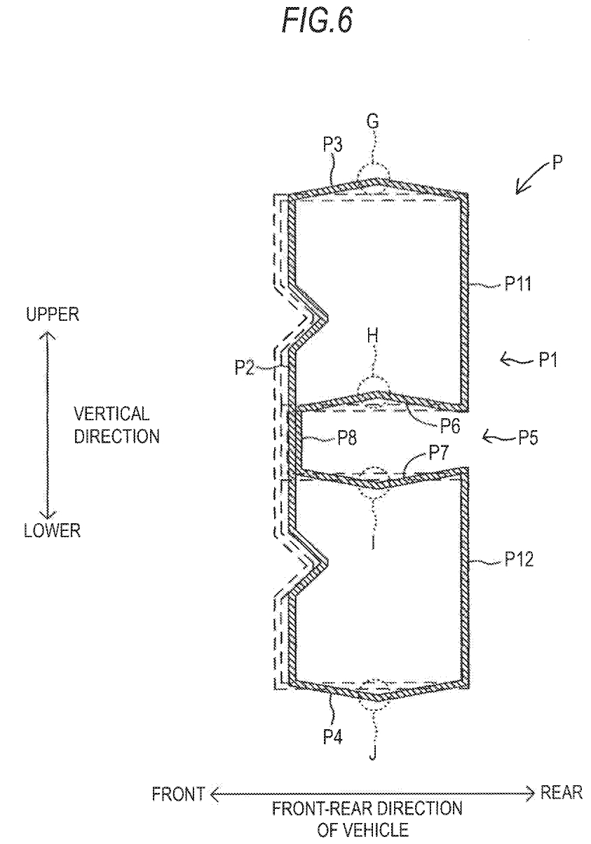

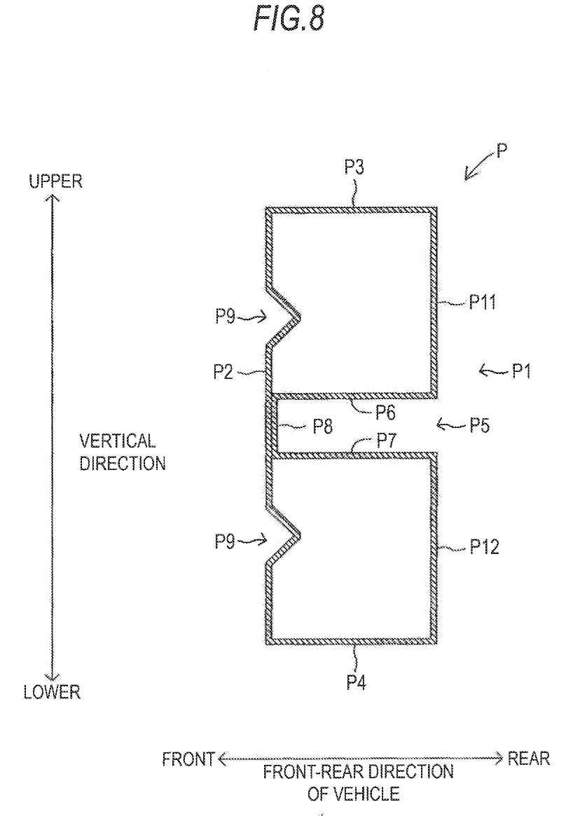

FIG. 6 is a schematic cross-sectional view illustrating a state where the vehicle bumper reinforcement P having a cross-section of the B shape illustrated in FIG. 8 is buckled by the impact load. In FIG. 6, the vehicle bumper reinforcement P before being buckled is illustrated in dot lines. In a case where the impact load acts on a front-wall section P2 of the vehicle bumper reinforcement P from the front side to the rear side, an upper-wall section P3 is buckled, for example, in portion G in FIG. 6, an upper side-wall section P6 is buckled in portion H, a lower side-wall section P7 is buckled in portion I and a lower-wall section P4 is buckled in portion J. The buckling in those portions occurs substantially at the same time. Accordingly, the vehicle bumper reinforcement P of the related art having a cross-section of the B shape is configured to be buckled in four locations against the impact load.

As described above, the number of the locations in which the vehicle bumper reinforcement 1 of the embodiment is buckled by the impact load is greater than the number of the locations in which the vehicle bumper reinforcement P having a cross-section of the B shape is buckled by the impact load. That there are a large number of locations which buckling occurs means that there are many portions receiving the impact load. In other words, the vehicle bumper reinforcement 1 of the embodiment is configured so as to receive the impact load in the portions greater in number than that of the vehicle bumper reinforcement having the cross-section of the B shape of the related art. Thus, the buckling strength of the vehicle bumper reinforcement of the embodiment is great.

In addition, according to the vehicle bumper reinforcement 1 of the embodiment, the concave sections (the first concave section 11a and the second concave section 12a) are provided in both the rear-wall section 11 and the front-wall section 12, and are formed so as to butt against the bottom-wall section of each concave section. Accordingly, the side-wall section forming each concave section is used as the rib against the impact load. The length of the side-wall section (the first upper side-wall section 113, the first lower side-wall section 114, the second upper side-wall section 123 and the second lower side-wall section 124) forming each concave section is shorter than the lengths of the upper-wall section 13 and the lower-wall section 14. It is understood that the buckling strength against the impact load acting on the rib in the axial direction is increased as the length of the rib being short. Therefore, as in the embodiment, the bottom-wall sections of the concave sections formed on the rear-wall section 11 and the front-wall section 12, respectively are configured so as to butt to each other and then the buckling strength can be further improved.

In addition, the vehicle bumper reinforcement 1 of the embodiment receives the impact load in six ribs. In a case of receiving the impact load in six ribs, six ribs arranged in parallel may be formed inside the vehicle bumper reinforcement. However, in this case, it is difficult to form the vehicle bumper reinforcement with a sheet of the plate-shaped member. On the other hand, the vehicle bumper reinforcement 1 of the embodiment is configured such that the bottom-wall sections of the concave sections which are formed in the rear-wall section 11 and the front-wall section 12 butt against each other, and a pair of side-wall sections forming each concave section, respectively are used as the ribs. Thus, the vehicle bumper reinforcement having six ribs can be simply formed with a sheet of plate-shaped member. In addition, as illustrated in FIG. 4, the first upper side-wall section 113 and the second upper side-wall section 123 functioning as the ribs are arranged in series and similarly, the first lower side-wall section 114 and the second lower side-wall section 124 functioning as the ribs are arranged in a series. The length of the rib can be shortened by the serial arrangement of the ribs. As a result, the buckling strength of the vehicle bumper reinforcement 1 can be improved.

In addition, according to the vehicle bumper reinforcement 1 of the embodiment, as can be seen from FIG. 4, each of concave sections 11a and 12a is formed so that the depth of the second concave section 12a is shallower than the depth of the first concave section 11a. In the embodiment, each of concave sections 11a and 12a is formed so that the depth of the second concave section 12a is 1/7 of the depth of the first concave section 11a. Each of concave sections 11a and 12a is formed so that the depth of the second concave section 12a is shallower than the depth of the first concave section 11a. Accordingly, the buckling strength can be further improved.

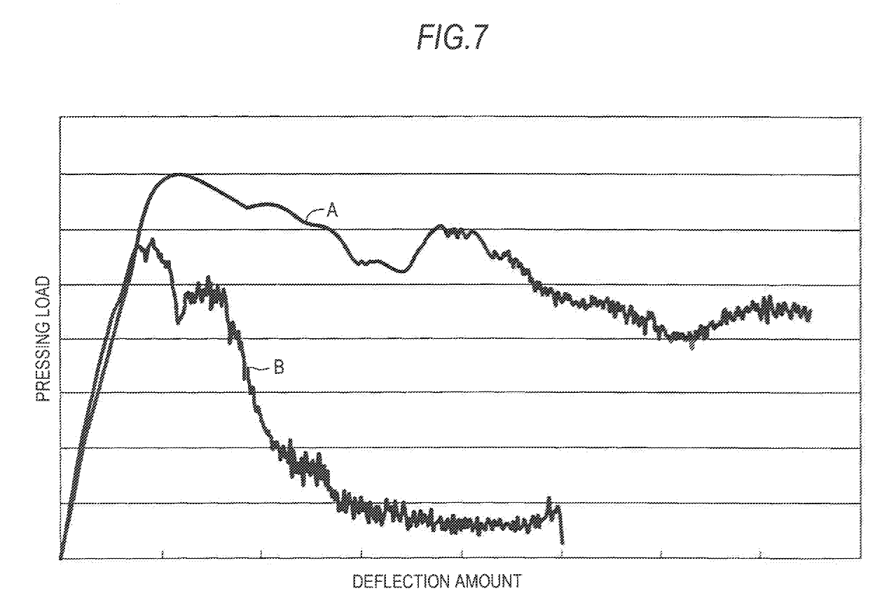

FIG. 7 is a graph illustrating a relationship between a deflection amount to the rear side of the vehicle bumper reinforcement 1 and a pressing load which the vehicle bumper reinforcement 1 receives from an object when the object is pressed in a case where the vehicle bumper reinforcement 1 of the embodiment is provided in the vehicle and the object is pressed on the front surface of the front-wall section 12. The lateral axis is a deflection amount and the vertical axis is the pressing load in FIG. 7. In addition, a graph A in FIG. 7 is a graph indicating a relationship between the deflection amount and the pressing load with respect to the vehicle bumper reinforcement 1 of the embodiment. A graph B in FIG. 7 is a graph indicating a relationship between the deflection amount and the pressing load with respect to the vehicle bumper reinforcement in which each of concave sections 11a and 12a is formed so that the depth of the second concave section 12a is 7 times of the depth of the first concave section 11a, in other words, with respect to the vehicle bumper reinforcement in which the depth of the second concave section 12a is deeper than the depth of the first concave section 11a. A maximum pressing load illustrated in the graph indicates the buckling load (the buckling strength).

As illustrated in FIG. 7, the buckling load of the vehicle bumper reinforcement 1 of the embodiment illustrated in the graph A is greater than the buckling load of the vehicle bumper reinforcement illustrated in the graph B. Accordingly, in a case where each of concave sections 11a and 12a is formed and then the second concave section 12a is shallower than the first concave section 11a, in other words, the depth of the concave section which is formed in the side on which the impact load acts is shallower than the depth of the concave section which is formed in the opposite side thereof, it is understood that the buckling strength is improved. The reason for this may be inferred as below. In other words, the side-wall sections (the second upper side-wall section 123 and the second lower side-wall section 124 in the vehicle bumper reinforcement 1 of the embodiment) forming the concave sections which are provided in a side on which the impact load acts are likely to be fallen by the impact load without buckling as the length thereof being longer, in other words, as the depth of the concave section provided in a side on which the impact load acts to be deeper. Specifically, the side-wall sections forming the concave sections thereof are likely to be fallen without buckling so that the openings of the concave sections spread. When such a falling occurs, the fallen portion cannot function as the rib and, as a result, the buckling strength is decreased. Meanwhile, the side-wall sections forming the concave sections are unlikely to be fallen by the impact load as the lengths of the side-wall sections forming the concave section provided in a side on which the impact load acts being shortened, in other words, the depth of the concave section provided in a side on which the impact load acts being shallow. Accordingly, the side-wall sections forming the concave sections function as effective ribs and, as a result, the buckling strength can be improved.

In the above, the embodiment disclosed here is described. However, this disclosure is not limited to the embodiment described above. For example, in the embodiment described above, an example, in which this disclosure is applied to the vehicle bumper reinforcement which is provided in the front of the vehicle, is described. However, this disclosure can be applied to the vehicle bumper reinforcement which is provided in the rear of the vehicle. In addition, in order to further increase the buckling strength, an example in which the depth of the second concave section 12a is shallower than the depth of the first concave section 11a is described. However, even though the depth of the second concave section 12a is deeper than the depth of the first concave section 11a, the improvement effect of the buckling strength can be expected compared to the vehicle bumper reinforcement of the related art having the cross-section of the B shape. In addition, as an example in which the depth of the second concave section 12a is shallower than the depth of the first concave section 11a, the case where the depth of the second concave section 12a is 1/7 of the depth of the first concave section 11a is described. However, the buckling strength can be sufficiently improved when the depth of the second concave section 12a is approximately ⅛ to ½ of the depth of the first concave section 11a. In a case where the depth of the second concave section 12a is smaller than ⅛ of the depth of the first concave section 118. the side-wall sections (the second upper side-wall section 123 and the second lower side-wall section 124) forming the second concave section 12a is very unlikely to function as the rib. In addition, in a case where the depth of the second concave section 12a is greater than ½ of the depth of the first concave section 11a, the effect of improvement of the buckling strength is weakened. In addition, a plurality of concave sections may be formed in the rear-wall section 11 and the front-wall section 12, respectively and the bottom-wall sections of the plurality of concave sections may be in accord with each other. According to the configuration, the number of the ribs against the impact load acting from the front-wall section 12 is increased. As described above, this disclosure may be changed without deviating from the gist thereof.

Aspects of this disclosure are further described below.

According to an aspect of this disclosure, there is provided a vehicle bumper reinforcement including: an inner-wall section which is formed in a long shape along a width direction of a vehicle and is connected to a member of a vehicle body side; an outer-wall section which is formed in a long shape so as to be arranged to face the inner-wall section along the width direction of the vehicle and on which an impact load acts from an outside; an upper-wall section which connects an upper end side of the inner-wall section and an upper end side of the outer-wall section; and a lower-wall section which connects a lower end side of the inner-wall section and a lower end side of the outer-wall section, wherein the inner-wall section has a first concave section with a bottom, which is formed along the longitudinal direction of the inner-wall section so as to be recessed towards the outside, wherein the outer-wall section has a second concave section with a bottom, which is formed along the longitudinal direction thereof so as to be recessed towards an inside, and wherein a bottom surface of the first concave section and a bottom surface of the second concave section are arranged to face each other so as to come into contact with each other.

In this case, the inner-wall section may have an upper inner-wall section positioned at an upper side from the first concave section and a lower inner-wall section positioned at a lower side from the first concave section, the outer-wall section may have an upper outer-wall section positioned at an upper side from the second concave section and a lower outer-wall section positioned at a lower side from the second concave section, the first concave section may be formed by a first upper side-wall section extending from a lower end of the upper inner-wall section to the outside, a first lower side-wall section extending from the upper end of the lower inner-wall section to the outside, and a first bottom-wall section connecting an outside end of the first upper-wall section and an outside end of the first lower-wall section, the second concave section may be formed by a second upper side-wall section extending from a lower end of the upper outer-wall section to the inside, a second lower side-wall section extending from an upper end of the lower outer-wall section to the inside, and a second bottom-wall section connecting an inside end of the second upper-wall section and an inside end of the second lower-wall section, and the first bottom-wall section and the second bottom-wall section may be arranged to face each other so that an outside surface of the first bottom-wall section and an inside surface of the second bottom-wall section come into contact with each other.

According to this disclosure, the impact load acting on the outer-wall section is transmitted to the upper-wall section and the lower-wall section, and, at the same time, is transmitted to the two side-wall sections (the second upper side-wall section and the second lower side-wall sect(on) which configure the second concave section provided in the outer-wall section. In addition, since the bottom-wall section (the second bottom-wall section) of the second concave section comes into contact with the bottom-wall section (the first bottom-wall section) configuring the first concave section formed in the inner-wall section, the impact load transmitted to the second upper side-wall section and the second lower side-wall section is transmitted to the first upper side-wall section and the first lower side-wall section configuring the first concave section via the second bottom-wall section and the first bottom-wall section. Accordingly, the impact load acting on the outer-wall section is transmitted to the upper-wall section, the lower-wall section, the second upper side-wall section, the second lower side-wall section, the first upper side-wall section, and the first lower side-wall section, respectively, at the same time. In other words, the impact load is transmitted to six ribs at the same time. Accordingly, the vehicle bumper reinforcement of this disclosure is buckled by the impact load in six locations thereby absorbing the impact load.

As described above, the vehicle bumper reinforcement of this disclosure is buckled by the impact load in six locations and the number of the buckling locations is greater than that of the locations (four locations) in which the vehicle bumper reinforcement of the related art having a cross-section of a B shape is buckled by the impact load. Accordingly, the buckling strength against the impact load is further improved.

In this disclosure, “outside” is referred to as a direction departing from the vehicle as progressing in the front side or the rear side and “inside” is referred to as a direction approaching the vehicle as progressing in the front side or the rear side. Accordingly, in a case where the vehicle bumper reinforcement is provided in the front of the vehicle, “outside” is referred to as the front side and “inside” is referred to as the rear side. On the other hand, in a case where the vehicle bumper reinforcement is provided in the rear of the vehicle, “outside” is referred to as the rear side and “inside” is referred to as the front side. In addition, “outside surface” is referred to as a surface facing “outside” and “inside surface” is referred to as a surface facing “inside”.

The depth of the second concave section formed in the outer-wall section may be shallower than the depth of the first concave section formed in the inner-wall section. In this case, the length of the first upper side-wall section in the front-rear direction of the vehicle is the same as the length of the first lower side-wall section in the front-rear direction of the vehicle. The length of the second upper side-wall section in the front-rear direction of the vehicle is the same as the length of the second lower side-wall section in the front-rear direction of the vehicle. The lengths of the second upper side-wall section and the second lower side-wall section in the front-rear direction of the vehicle may be shorter than the lengths of the first upper side-wall section and the first lower side-wall section in the front-rear direction of the vehicle. According to the configuration described above, the buckling strength against the impact load is further improved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle bumper reinforcement comprising:
an inner-wall section which is formed in a long shape along a width direction of a vehicle and is connected to a member of a vehicle body side;
an outer-wall section which is formed in a long shape so as to be arranged to face the inner-wall section along the width direction of the vehicle and on which an impact load acts from an outside;
an upper-wall section which connects an upper end side of the inner-wall section and an upper end side of the outer-wall section; and
a lower-wall section which connects a lower end side of the inner-wall section and a lower end side of the outer-wall section,
wherein the inner-wall section has a first concave section with a bottom, which is formed along a longitudinal direction of the inner-wall section so as to be recessed towards the outside,
wherein the outer-wall section has a second concave section with a bottom, which is formed along a longitudinal direction thereof so as to be recessed towards an inside, and
wherein a bottom surface of the first concave section and a bottom surface of the second concave section are arranged to face each other so as to come into contact with each other.

2. The vehicle bumper reinforcement according to claim 1,
wherein a depth of the second concave section is shallower than a depth of the first concave section.

3. The vehicle bumper reinforcement according to claim 1,
wherein the inner-wall section has an upper inner-wall section positioned at an upper side from the first concave section and a lower inner-wall section positioned at a lower side from the first concave section,
wherein the outer-wall section has an upper outer-wall section positioned at an upper side from the second concave section and a lower outer-wall section positioned at a lower side from the second concave section,
wherein the first concave section is formed by a first upper side-wall section extending from a lower end of the upper inner-wall section to the outside, a first lower side-wall section extending from the upper end of the lower inner-wall section to the outside, and a first bottom-wall section connecting an outside end of the first upper-wall section and an outside end of the first lower-wall section,
wherein the second concave section is formed by a second upper side-wall section extending from a lower end of the upper outer-wall section to the inside, a second lower side-wall section extending from an upper end of the lower outer-wall section to the inside, and a second bottom-wall section connecting an inside end of the second upper-wall section and an inside end of the second lower-wall section, and
wherein the first bottom wall section and the second bottom-wall section are arranged to face each other so that an outside surface of the first bottom-wall section and an inside surface of the second bottom-wall section come into contact with each other.
